(19) United States
(12) Patent Application Publication
(10) Pub. No.: US 2026/0274270 A1
(43) Pub. Date: Sep. 17, 2026

(54) VEHICLE SPEED PREDICTION METHOD AND SYSTEM CONSIDERING DYNAMIC TRAFFIC ENVIRONMENT IN CAR-FOLLOWING SCENARIOS

(71) Applicant: CHANG'AN UNIVERSITY, Xi'an (CN)

(72) Inventors: Xuan ZHAO, Xi'an (CN); Rui LIU, Xi'an (CN); Rong HUANG, Xi'an (CN); Shu WANG, Xi'an (CN); Yisong CHEN, Xi'an (CN); Jian MA, Xi'an (CN); Yiming YE, Xi'an (CN); Qifan XUE, Xi'an (CN); Meng ZHOU, Xi'an (CN)

(21) Appl. No.: 19/682,312

(22) Filed: May 19, 2026

Related U.S. Application Data
(63) Continuation of application No. PCT/CN2025/132200, filed on Nov. 3, 2025.

(30) Foreign Application Priority Data
Nov. 1, 2024 (CN) 202411552408.X

(51) Int. Cl. B60W 40/105; B60W 30/165; B60W 50/00; G06N 3/0464; G06V 20/58

(52) U.S. Cl. CPC B60W 40/105; B60W 30/165; B60W 50/0097; G06N 3/0464; G06V 20/58; B60W 2050/0031; B60W 2050/0083; B60W 2420/403; B60W 2520/105; B60W 2540/10; B60W 2552/05; B60W 2554/406; B60W 2554/80; B60W 2556/35

(57) ABSTRACT

A method for predicting vehicle speed considering a dynamic traffic environment in a car-following scenario includes following steps: car-following case data is extracted by setting a standard and a threshold for a car-following process in a naturalistic driving dataset; a traffic environment feature related to the car-following case data is obtained by using a target detection algorithm, a vehicle dynamics parameter is extracted from the car-following case data and fused with the traffic environment feature, and normalization processing is performed to obtain a fused feature; a redundant variable is removed from the fused feature by a combined feature selection method; and the fused feature after removal of the redundant variable is divided into datasets to train a pre-established Informer-FDR vehicle speed prediction model, thereby obtaining a vehicle speed prediction result.

### CROSS-REFERENCE TO RELATED APPLICATIONS

This application is a continuation of International Patent Application No. PCT/CN2025/132200, filed on Nov. 3, 2025, which claims the benefit of priority from Chinese Patent Application No. 202411552408.X, filed on Nov. 1, 2024. The content of the aforementioned application, including any intervening amendments made thereto, is incorporated herein by reference in its entirety.

### TECHNICAL FIELD

This application relates to vehicle speed prediction, and more particularly to a vehicle speed prediction method and system considering dynamic traffic environment in car-following scenarios.

### BACKGROUND

With the rapid development of driver-assistance systems, automotive intelligence has emerged as a critical solution for reducing traffic accidents and alleviating congestion. Research indicates that if a driver-assistance system can provide timely warnings to a driver, traffic accident rate can be reduced by 60%, underscoring the critical role of driver-assistance systems in enhancing road safety. As accurately predicting vehicle speed is key to achieving efficient driver-assistance systems and intelligent driving technologies, within these systems, vehicle speed prediction models are particularly crucial. Furthermore, rear-end collisions account for 60%-70% of all traffic accidents. By accurately predicting vehicle speed and behavior, driver-assistance systems can better avoid potential collision risks, thereby reducing the incidence of rear-end collisions. Therefore, accurately predicting vehicle speed in car-following scenarios holds significant research and practical value for enhancing the effectiveness of driver-assistance systems, improving human-like driving capabilities, and reducing rear-end collisions.

However, achieving accurate vehicle speed prediction is a complex task. In car-following scenarios, a driver is influenced not only by the driving behavior of the vehicle ahead but also by the complex interactions with motor vehicles, non-motor vehicles, and pedestrians in surrounding lanes. This causes the following vehicle's speed to exhibit significant fluctuation characteristics during the car-following cycle.

Existing methods rarely consider the impact of these dynamic environmental factors on the driver's speed choice during the car-following process. Furthermore, most current neural networks can only retrospectively process linear-sized historical data when predicting vehicle speed. This results in limited receptive fields, computational redundancy, and uncertainty regarding the impact of future information on time series predictions. Additionally, increasing network depth may slow down model training and degrade model performance.

### SUMMARY

In view of the deficiencies in the prior art, this application provides a vehicle speed prediction method and system considering a dynamic traffic environment in car-following scenarios, which improves real-time performance and accuracy of vehicle speed prediction in actual complex driving environments.

Technical solutions of the present disclosure are described as follows.

In a first aspect, this application provides a method for predicting vehicle speed considering a dynamic traffic environment in a car-following scenario, comprising:
extracting car-following case data by setting a standard and a threshold for a car-following process in a naturalistic driving dataset;
obtaining a traffic environment feature related to the car-following case data by using a target detection algorithm, and extracting a vehicle dynamics parameter from the car-following case data, fusing the vehicle dynamics parameter with the traffic environment feature, and performing normalization processing to obtain a fused feature;
removing a redundant variable from the fused feature by using a combined feature selection method; and
dividing the fused feature after removal of the redundant variable into datasets, training a pre-established Informer-FDR (Fusion features, Dilated causal convolution, and Residual connection) vehicle speed prediction model, and obtaining a vehicle speed prediction result by using a trained Informer-FDR vehicle speed prediction model.

In some embodiments, in the step of “extracting car-following case data by setting the standard and the threshold for the car-following process in the naturalistic driving dataset”, the standard and threshold for the car-following process are as follows, data is selected as the car-following case data when following conditions are simultaneously met:
a relative speed between a leading vehicle and a following vehicle is less than 2.5 m/s;
a lateral offset between the leading vehicle and the following vehicle is less than 2.5 m; and
a following duration is greater than 10 s; and
extracted car-following case data is divided into two road types: urban roads and highways.

In some embodiments, the step of “obtaining the traffic environment feature related to the car-following case data by using the target detection algorithm” comprises:
using a YOLOv5 (You Only Look Once version 5) target detection algorithm to detect a vehicle and a traffic participant in adjacent lanes, and defining a traffic density based on the number of vehicles traveling in a same direction as a host vehicle captured by a camera, wherein a case where the number of vehicles traveling in the same direction is 1 to 2 is defined as a low traffic density, a case where the number of vehicles traveling in the same direction is 3 to 4 is defined as a medium traffic density, and a case where the number of vehicles traveling in the same direction is greater than 4 is defined as a high traffic density; and a pedestrian and a cyclist recognized by the YOLOv5 target detection algorithm are merged into a unified category, defined as vulnerable road users, as input features for the Informer-FDR vehicle speed prediction model.

In some embodiments, when extracting the vehicle dynamics parameter from the car-following case data, driving information of a host vehicle is read via a CAN bus, the driving information of the host vehicle comprising a speed, an acceleration, a relative distance, an accelerator pedal position, and time headway.

In some embodiments, the step of “removing the redundant variable from the fused feature by using the combined feature selection method” comprises:
calculating a correlation between a candidate input feature and a speed of a host vehicle using Maximal Information Coefficient (MIC), Classification and Regression Tree (CART), Random Forest (RF), and eXtreme Gradient Boosting (XGBoost) algorithm; and
calculating an average value for each candidate variable by summing correlation results of four different algorithms and dividing by a total number of algorithms, sequentially calculating and ranking all variables, and selecting top-ranked variables with highest importance as model inputs based on the ranking.

In some embodiments, the Informer-FDR vehicle speed prediction model is established based on the Informer deep learning model through steps of:

in a rolling prediction setting with a fixed window size, an input at a time point t is expressed as:

$$X = \{ {x}_{1} , {x}_{2} , … , {x}_{N} \vert {x}_{i} ∈ {▯}^{L \times D} \} ;$$

wherein L is a sample sequence length, and D is a feature dimension; and in X, a single data sample is expressed as:

$${x}_{i} = \{ {t}_{i}^{1} , {t}_{i}^{2} , … , {t}_{i}^{L} \vert {t}_{i}^{j} ∈ {▯}^{1 \times D} \} ;$$

wherein

$${t}_{i}^{j}$$

represents data of an i-th model input at a j-th time step;
a speed of a host vehicle is used as an output indicator:

$$Y = \{ {y}_{1} , {y}_{2} , … , {y}_{N} \vert {y}_{i} ∈ {▯}^{1} \} ;$$

wherein yᵢ represents an output of the i-th model at each time step;
an encoder of the Informer deep learning model is formed by stacking a multi-head probabilistic sparse (ProbSparse) self-attention mechanism and a distillation operation:

$$\overline{A} ( Q , K , V ) = Softmax ( \frac{\overline{Q} {K}^{T}}{\sqrt{d}} ) V ;$$

wherein Q̅ is a sparse matrix containing sparsity measurements; Q and K generated during an encoder training process represent a query vector and a key vector, respectively; and V represents a value vector; d represents an input dimension; and a ProbSparse self-attention mechanism is expressed as:

$$\overline{M} ( {q}_{i} , K ) = max \{ \frac{{q}_{i} {k}_{j}^{T}}{\sqrt{d}} \} - \frac{1}{{L}_{K}} {\sum }_{j = 1}^{{L}_{K}} \frac{{q}_{i} {k}_{j}^{T}}{\sqrt{d}} ;$$

wherein L_{K} is expressed as 1/L_{K}=q(kⱼ|qᵢ); i queries for sparsity measurements are expressed as qᵢ; and qᵢ and kⱼ are derived from Q and K, respectively;
the Informer deep learning model incorporates a convolutional layer and a max pooling layer between each pair of self-attention layers to reduce an input length; after a preceding self-attention layer, a convolutional layer with a kernel size of 3 and a stride of 1 is employed to enhance perception of contextual information features; subsequently, a max pooling layer with a kernel size of 3 and a stride of 2 is employed to prioritize main features, thereby generating smaller but more concentrated feature maps for subsequent self-attention layers:

$${X}_{j + 1}^{t} = Max Pool ( ELU ( Conv 1 d ( {[ {X}_{j}^{t} ]}_{A B} ) ) ) ;$$

wherein the ProbSparse self-attention is contained in [⋅]_{AB}; 1-D convolutional filtering is implemented through Conv(⋅); ELU(⋅) represents an activation function; and the encoder combines the ProbSparse self-attention and the distillation operation to generate the feature map;
a time series X_{feed_de}^{t} input in the decoder of the Informer deep learning model is divided into two parts: a known sequence

$${X}_{t o k e n}^{t}$$

before a predicted point and a prediction sequence

$${X}_{0}^{t}$$

requiring future data masking:

$${X}_{feed \_ de}^{t} = Concat ( {X}_{t o k e n}^{t} , {X}_{0}^{t} ) ∈ {R}^{( {L}_{token} + {L}_{y} ) {d}_{mod el}} ;$$

wherein Lₜₒₖₑₙ is a length of a start token sequence; L_{y} is a length of the prediction sequence; and d_{model} is a model dimension;
positional encoding is performed on each input information of sequence according to following formulas:

$${PE}_{( pos , 2 j )} = sin \frac{pos}{{( 2 {L}_{X} )}^{2 j} / {d}_{mod el}} ; and$$

$${PE}_{( pos , 2 j )} = cos \frac{pos}{{( 2 {L}_{X} )}^{2 j} / {d}_{mod el}} ;$$

and
wherein pos represents a feature vector position, and d_{model} represents a feature vector dimension; and given importance of time information for time series prediction, time information in the time series is encoded, and position information and time information are integrated and input into the Informer deep learning model.

In some embodiments, wherein the pre-established Informer-FDR vehicle speed prediction model is configured to replace a max pooling layer of a distillation layer in a decoder of an Informer deep learning model with an average pooling layer, and change a convolutional layer to dilated causal convolution; the dilated causal convolution consists of causal convolution and dilated convolution; the causal convolution is subject to time constraint limitations, convolving an output at time t only with elements at time t and earlier in a previous layer to ensure causality in time series prediction, so that network output information is only influenced by past input information;

an operation of the dilated convolution is expressed as:

$$F ( s ) = {\sum }_{i = 0}^{K - 1} {F}_{i} * {X}_{t - d \cdot i} ;$$

wherein K is a size of a convolution kernel, s is an element of X, Fᵢ is a weight of the convolution kernel, t is a time step, and t−d·i denotes a past direction;
the pre-established Informer-FDR vehicle speed prediction model is configured to introduce Parametric Rectified Linear Unit (PReLU) as an activation function of the distillation layer, PReLU shifts an output mean toward zero, and an improved distillation operation is as follows:

$${X}_{j + 1}^{t} = AvgPool ( P Re LU ( D C C o n v ( {[ {X}_{j}^{t} ]}_{A B} ) ) ) ;$$

wherein ProbSparse self-attention is contained in [⋅]_{AB}; the dilated causal convolution is implemented through DCConv(⋅); PReLU(⋅) represents the activation function, and a final output is generated through AvgPool(⋅); and
the pre-established Informer-FDR vehicle speed prediction model is configured to incorporate a residual connection module; the residual connection module consists of three ProbSparse self-attention layers and two distillation layers, and three ProbSparse self-attention layers are a first ProbSparse self-attention layer, a second ProbSparse self-attention layer, a third ProbSparse self-attention layer; to ensure that feature maps output by the first Prob Sparse self-attention layer and the third ProbSparse self-attention layer have the same shape when added together, a 1×1 convolution is used to merge an output of the first ProbSparse self-attention layer with an output of the third ProbSparse self-attention layer in a main encoder, ensuring effective transmission of feature information.

In a second aspect, this application provides a system for predicting vehicle speed considering a dynamic traffic environment in a car-following scenario, comprising:
a car-following case data extraction module;
a feature fusion and normalization processing module;
a redundant variable removal module; and
a vehicle speed prediction model training and prediction output module;
wherein the car-following case data extraction module is configured for extracting car-following case data by setting a standard and a threshold for a car-following process in a naturalistic driving dataset;
the feature fusion and normalization processing module is configured for obtaining a traffic environment feature related to the car-following case data by using a target detection algorithm, and extracting a vehicle dynamics parameter from the car-following case data, fusing the vehicle dynamics parameter with the traffic environment feature, and performing normalization processing to obtain a fused feature;
the redundant variable removal module is configured for removing a redundant variable from the fused feature by using a combined feature selection method; and
the vehicle speed prediction model training and prediction output module is configured for dividing the fused feature after removal of the redundant variable into datasets, training a pre-established Informer-FDR vehicle speed prediction model, and obtaining a vehicle speed prediction result by using a trained Informer-FDR vehicle speed prediction model.

The beneficial effects of the present disclosure are as follows.

By setting the standards and thresholds for the car-following process in the naturalistic driving dataset, the present application effectively extracts car-following case data, enabling targeted mining of the car-following data. This enables a more comprehensive understanding and analysis of dynamic car-following behaviors in the driving environment. A target detection algorithm is used to obtain traffic environment features related to the car-following case data. Vehicle dynamics parameters are extracted from the car-following case data and then fused with the traffic environment features. The fusion of the traffic environment features and the vehicle dynamics parameters effectively reflects the dynamic interaction characteristics between the driver and the traffic environment, as well as potential traffic conflicts, thereby enhancing the model's understanding of complex driving environments. The fused features, after removing redundant variables, are divided into datasets to train a pre-established Informer-FDR vehicle speed prediction model. The trained Informer-FDR vehicle speed prediction model is then used to obtain vehicle speed prediction results. Compared with other models, the Informer-FDR vehicle speed prediction model in the present application achieves the best prediction performance, and can more accurately capture the fluctuation trends of data sequences and exhibits a higher degree of fitness with actual data. In particular, the Informer-FDR vehicle speed prediction model exhibits smaller prediction deviations at extreme points, demonstrating its ability to more accurately capture random occurrences within traffic scenarios.

Furthermore, the present application reduces the high computational complexity of the Informer-FDR vehicle speed prediction model by employing the ProbSparse self-attention mechanism, thereby addressing the difficulty of applying Transformer-based deep learning models to in-vehicle platforms.

Furthermore, the Informer-FDR vehicle speed prediction model established in the present application considers the impact of dynamic traffic environments on vehicle speed fluctuations, achieves global feature extraction over long car-following cycles, and solves the degradation problem of deep networks.

Furthermore, the present application introduces dilated causal convolution, which broadens the receptive field of the Informer-FDR vehicle speed prediction model, ensures causality in time series prediction, and avoids the loss of extreme position information and information leakage.

Furthermore, the Informer-FDR vehicle speed prediction model incorporates a residual connection module, which accelerates the convergence of the Informer-FDR vehicle speed prediction model and enhances training stability.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

To illustrate the embodiments of the present disclosure and the technical solution more clearly, the drawings required in the embodiments will be briefly described below. Obviously, presented in the drawings are merely some embodiments of the present disclosure, which are not intended to limit the disclosure. For those skilled in the art, other drawings may also be obtained according to the drawings provided herein without paying creative efforts.

FIG. 1 is a flowchart of a vehicle speed prediction method considering dynamic traffic environment in car-following scenarios according to an embodiment of the present disclosure;

FIG. 2 is a network structure diagram of an Informer-FDR vehicle speed prediction model established according to an embodiment of the present disclosure;

FIG. 3 is a structural diagram of a dilated causal convolution according to an embodiment of the present disclosure;

FIG. 4 shows test results of the vehicle speed prediction method according to an embodiment of the present disclosure; and

FIG. 5 is a diagram comparing prediction performance between the Informer-FDR vehicle speed prediction model and other algorithm models.

### DETAILED DESCRIPTION OF EMBODIMENTS

The technical solutions in the embodiments of the present disclosure will be clearly and completely described below in conjunction with the accompanying drawings of the present disclosure. Described below are merely some embodiments of the disclosure. For those skilled in the art, other embodiments obtained based on these embodiments without paying creative efforts should fall within the scope of the disclosure.

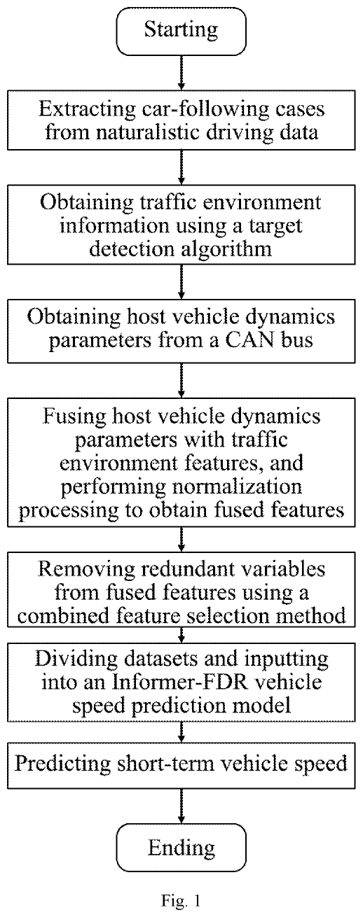

As shown in FIG. 1, the present disclosure provides a method for predicting vehicle speed considering a dynamic traffic environment in a car-following scenario in this embodiment. The method mainly includes the following steps. Firstly, car-following case data is effectively extracted by setting standards and thresholds for a car-following process in a naturalistic driving dataset. Secondly, a target detection algorithm is used to obtain relevant environment features. Vehicle dynamics parameters under car-following segments are extracted from a CAN bus and fused with environment features. Then, a combined feature selection method is used to eliminate redundant variables, thereby improving model prediction accuracy. Normalization processing is performed to obtain the fused features. Finally, the dataset is divided into a training set, a test set, and a validation set and input into a pre-established Informer-FDR vehicle speed prediction model for training and testing. Vehicle speed prediction results are ultimately obtained.

In an embodiment, the method is deployed in a vehicle speed prediction system of a host vehicle. The system includes a forward-facing camera, a wide-angle camera, a CAN-BUS interface, vehicle sensors, an onboard computing unit, an advanced driver-assistance system (ADAS) controller, a human-machine interface, and a vehicle control unit. The cameras capture images of traffic participants including a leading vehicle, vehicles in adjacent lanes, pedestrians, and cyclists. The CAN-BUS interface and the vehicle sensors collect host vehicle parameters including speed, acceleration, relative distance, and time headway. The onboard computing unit executes a target detection, feature extraction, feature fusion, and the Informer-FDR vehicle speed prediction model. Prediction results are output to the human-machine interface, the ADAS controller, a brake control unit, a drive control unit, and a vehicle controller for driving warning, longitudinal speed strategy adjustment, or generation of acceleration, deceleration, and braking control commands.

After the onboard computing unit outputs the predicted vehicle speed over a short-term future horizon, the predicted time headway, the predicted time to collision, and the predicted deceleration demand are calculated in combination with the relative distance, relative speed, and time headway. When the predicted time headway is below a preset threshold, the predicted time to collision is below a preset threshold, the predicted speed of the host vehicle is higher than the speed of the leading vehicle, and the relative distance is continuously decreasing, the system issues an audible, visual, or haptic warning through the human-machine interface. When a risk level is relatively high, the ADAS controller adjusts the target vehicle speed and the longitudinal acceleration request based on the predicted vehicle speed, and sends deceleration, braking, or drive torque reduction control commands to the brake control unit and the drive control unit via the vehicle controller. When the predicted vehicle speed is lower than the target vehicle speed, and the safe distance is sufficient, the ADAS controller sends the acceleration command to the drive control unit. When a deviation between the predicted vehicle speed and the target vehicle speed is within an allowable range, the vehicle is controlled to maintain the current following speed.

The implementation of the complete vehicle speed prediction method in the embodiment of the present disclosure is mainly divided into four main steps: acquisition of car-following data, acquisition of traffic environment information based on the target detection algorithm, feature fusion and redundant variable elimination, and establishment of the Informer-FDR vehicle speed prediction model for vehicle speed prediction.

Step 1: Acquisition of car-following data, specifically including the following steps.

Step 1.1: A comprehensive data acquisition system consisting of four cameras is installed on the host vehicle. The comprehensive data acquisition system includes a facial recognition camera, a pedal camera, the forward-facing camera, and a wide-angle forward-facing camera.

Step 1.2: Video data captured by the forward-facing camera is used to identify traffic participants. Data related to actual vehicle motion, such as vehicle speed, acceleration, steering wheel angle, and mileage, is extracted from a CAN-BUS system.

Step 1.3: Car-following case data is extracted by setting standards and thresholds for the car-following process. All car-following case data must meet specified thresholds. If any of these thresholds are not met, the corresponding event is not included in the initial car-following case database. The set thresholds are as follows:

1) The relative speed between the leading vehicle and the following vehicle is less than 2.5 m/s.

2) The lateral offset between the leading vehicle and the following vehicle is less than 2.5 m.

3) The following duration is greater than 10 s.

Furthermore, significant differences exist in traffic conditions and driving behaviors between urban roads and highways, which lead to differences in vehicle following behavior. In the embodiment of the present disclosure, car-following cases are divided into two road types: urban roads and highways. These road types are used as input features for the model, enabling the model to better understand and learn car-following behaviors under different road contexts.

Step 2: Acquisition of traffic environment information based on the target detection algorithm, specifically including the following steps.

Step 2.1: A YOLOv5 target detection algorithm is used to detect other vehicles and traffic participants in adjacent lanes. Traffic density is defined based on the number of vehicles traveling in the same direction as the host vehicle captured by the forward-facing camera. A case where the number of vehicles traveling in the same direction is 3 to 4 is defined as the medium traffic density. A case where the number of vehicles traveling in the same direction is greater than 4 is defined as high traffic density.

Step 2.2: In traffic environments, drivers are frequently influenced by individuals who may face higher risks on the road, which in turn affects their driving behavior. For this reason, pedestrians and cyclists recognized by the target detection algorithm are merged into a unified category, named vulnerable road users (VRUs), and used as input features for the model.

Step 3: Feature fusion and redundant variable elimination, specifically including the following steps.

Step 3.1: Vehicle dynamics parameters extracted from the CAN-BUS system, including speed, acceleration, relative distance, accelerator pedal position, and time headway, are fused with traffic environment information obtained by the target detection algorithm. Normalization processing is then performed.

Step 3.2: The MIC, CART, RF, and XGBoost algorithms are used to calculate correlations between candidate input features and the host vehicle speed. An average value for each candidate variable is calculated by summing the correlation results of the four different algorithms and dividing by the total number of algorithms. All variables are sequentially calculated and ranked. Based on the ranking, the seven variables with the highest importance are selected as inputs for the model.

### Step 4: Establishment of the Informer-FDR Vehicle Speed Prediction Model for Vehicle Speed Prediction

The Informer-FDR vehicle speed prediction model includes an Informer time series prediction model, a dilated causal convolution module, and a residual connection module.

The Informer time series prediction model is an improvement over the Transformer model. The Informer time series prediction model utilizes a multi-head ProbSparse self-attention mechanism to assign greater weights to important features, thereby reducing the time complexity of the network model. At the same time, distillation operations are used between self-attention layers to decrease the input length for the next layer. A generative inference decoding method is employed to improve prediction speed and address the long-term dependency problem in time series data.

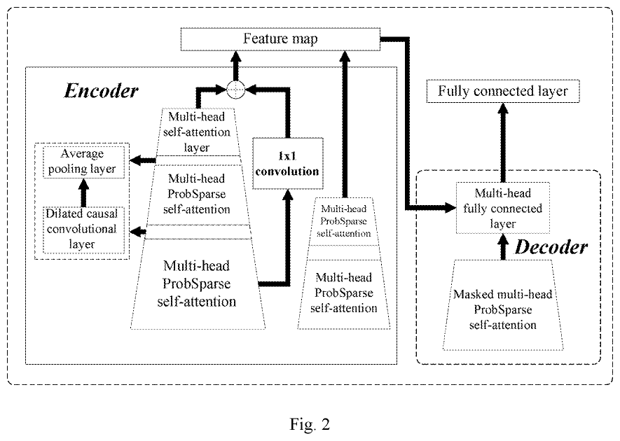

The Informer-FDR model in the embodiment of the present disclosure is an improvement over the Informer model. Dilated causal convolution is used to replace the conventional convolutional layer in the distillation layer between attention blocks in the original encoder. An average pooling layer is introduced to enhance model performance. The activation function in the distillation layer is set to PReLU to accelerate model convergence. In addition, the residual connection module is incorporated to enable deep cross-layer transmission of information. This design not only enhances training stability but also alleviates the problem of deep network degradation. The overall network structure is shown in FIG. 2.

### Step 4.1: Establishment of the Informer Deep Learning Model

The Informer time series prediction model utilizes the multi-head ProbSparse self-attention mechanism to assign greater weights to important features, thereby reducing the time complexity of the network model. Simultaneously, distillation operations are used between self-attention layers to reduce the input length for the next layer. Furthermore, generative inference decoding is employed to improve prediction speed, addressing the long-term dependencies in time series data.

In a rolling prediction setting with a fixed window size, the input at a time point t is expressed as:

$$X = \{ {x}_{1} , {x}_{2} , … , {x}_{N} \vert x , ∈ {⊓}^{L \times D} \} .$$

In the formula above, L is a sample sequence length, and D is a feature dimension; and in X, a single data sample is expressed as:

$${x}_{i} = \{ {t}_{i}^{1} , {t}_{i}^{2} , … , {t}_{i}^{L} \vert {t}_{i}^{j} ∈ {⊓}^{1 \times D} \} .$$

In the formula above,

$${t}_{i}^{j}$$

represents the data of the i-th model input at the j-th time step. Generally, the host vehicle speed is used as the output indicator, and the label Y is recorded as:

$$y = \{ {y}_{1} , {y}_{2} , … , {y}_{N} \vert {y}_{i} ∈ {▯}^{1} \} .$$

In the formula above, yᵢ represents an output of the i-th model at each time step.

In the Informer deep learning model, the encoder is formed by stacking the multi-head ProbSparse self-attention mechanism and the distillation operations.

Traditional self-attention mechanism incurs the cost of quadratic dot-product computations, which is the main factor limiting the prediction and training speed. The ProbSparse self-attention mechanism selects only a few dot-product pairs with higher scores while ignoring other dot-product pairs with lower scores, thereby reducing time complexity and memory usage. The specific operation is as follows:

$$\overline{A} ( Q , K , V ) = Softmax ( \frac{\overline{Q} {K}^{T}}{\sqrt{d}} ) V .$$

In the formula above, Q̅ is a sparse matrix containing sparsity measurements; Q and K generated during an encoder training process represent a query vector and a key vector, respectively; and V represents a value vector; and d represents an input dimension.

The ProbSparse self-attention mechanism is expressed as:

$$\overline{M} ( {q}_{i} , K ) = max \{ \frac{{q}_{i} {k}_{j}^{T}}{\sqrt{d}} \} - \frac{1}{{L}_{K}} {\sum }_{j - 1}^{{L}_{K}} \frac{{q}_{i} {k}_{j}^{T}}{\sqrt{d}} .$$

In the formula above, L_{K} is expressed as 1/L_{K}=q(kⱼ|qᵢ); i queries for sparsity measurements are expressed as qᵢ; and qᵢ and kⱼ are derived from Q and K, respectively.

In practice, the input lengths of the query vector and the key vector are usually equal in self-attention computation, resulting in both the total time complexity and space complexity of O(L log L) for the ProbSparse self-attention mechanism. The ProbSparse self-attention mechanism selects results with higher scores in the sparsity measurement and calculates the corresponding scores.

The Informer deep learning model incorporates the convolutional layer and the max pooling layer between each pair of self-attention layers to reduce the input length. After the preceding self-attention layer, the convolutional layer with a kernel size of 3 and a stride of 1 is employed to enhance perception of contextual information features. Subsequently, the max pooling layer with a kernel size of 3 and a stride of 2 is employed to prioritize main features, thereby generating smaller but more concentrated feature maps for subsequent self-attention layers:

$${X}_{j + 1}^{t} = Max Pool ( ELU ( Conv 1 d ( {[ {X}_{j}^{t} ]}_{AB} ) ) ) .$$

In the formula above, the ProbSparse self-attention is contained in [⋅]; 1-D convolutional filtering is implemented through Conv(⋅); ELU(⋅) represents the activation function; and the encoder combines the ProbSparse self-attention and the distillation operation to generate the feature map.

The time series X_{feed_de}^{t} input in the decoder of the Informer deep learning model is divided into two parts: a known sequence

$${X}_{token}^{t}$$

before a predicted point and a prediction sequence

$${X}_{0}^{t}$$

requiring future data masking:

$${X}_{feed \_ de}^{t} = Concat ( {X}_{token}^{t} , {X}_{0}^{t} ) ∈ {R}^{( {L}_{token} + {L}_{y} ) {d}_{model}} .$$

In the formula above, Lₜₒₖₑₙ is the length of a start token sequence; L_{y} is the length of the prediction sequence; and d_{model} is a model dimension.

In vehicle speed prediction, time-series information represents the operational state of the vehicle at each moment, where temporal order is critical. Since the Informer model lacks iterative operations like RNNs, positional encoding is applied to each input information of sequence, as detailed in the formulas:

$${PE}_{( pos , 2 j )} = sin \frac{pos}{{( 2 {L}_{X} )}^{2 j} / {d}_{mod el}} ; and$$

$${PE}_{( pos , 2 j )} = cos \frac{pos}{{( 2 {L}_{X} )}^{2 j} / {d}_{mod el}} .$$

In the formulas above, pos represents the feature vector position, and d_{model} represents the feature vector dimension; and given importance of time information for time series prediction, time information in the time series is encoded, and position information and time information are integrated and input into the Informer deep learning model.

To address several key limitations of the Informer model when applied to vehicle speed prediction in car-following scenarios: traditional convolutional layers can only look back at linear-sized historical information; stacking self-attention blocks with standard convolutional layers may lead to redundant and meaningless computations, potentially causing future information leakage. This embodiment resolves these issues by introducing dilated causal convolutions.

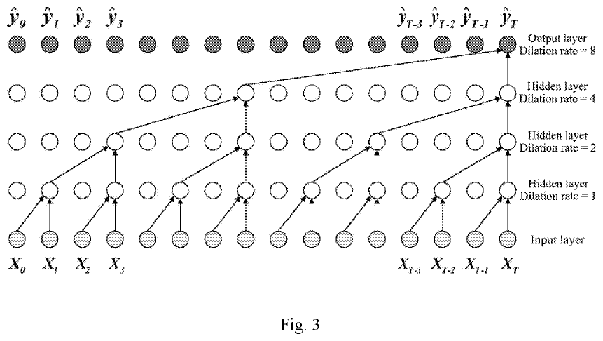

Step 4.2: The max pooling layer of the distillation layer in the decoder of the Informer model is replaced with the average pooling layer, and the conventional convolutional layer is changed to the dilated causal convolution. The structure of the dilated causal convolution is shown in FIG. 3.

The dilated causal convolution consists of two parts: causal convolution and dilated convolution. Unlike traditional convolution, causal convolution is subject to time constraint limitations. It convolves the output at time t only with elements at time t and earlier in the previous layer to ensure causality in time series prediction, so that the output information of the network is only influenced by past input information. The dilated convolution operation is as follows:

$$F ( s ) = {\sum }_{i = 0}^{K - 1} {F}_{i} * {X}_{t - d \cdot i} .$$

In the formula above, K is the size of the convolution kernel, s is the element of X, Fᵢ is the weight of the convolution kernel, tis the time step, and t−d·i denotes the past direction.

Building upon this, PReLU is introduced as the activation function for the distillation layer. Compared to the exponential linear unit (ELU), PReLU shifts the output mean toward zero without significantly increasing computational complexity or overfitting risk, thereby promoting faster model convergence. The improved distillation operation is as follows:

$${X}_{j + 1}^{t} = AvgPool ( P Re LU ( DCConv ( {[ {X}_{j}^{t} ]}_{AB} ) ) ) .$$

The ProbSparse self-attention is contained in [⋅]_{AB}; the dilated causal convolution is implemented through DCConv(⋅); PReLU(⋅) represents the activation function, and a final output is generated through AvgPool(⋅).

Step 4.3: The residual connection module is added. The residual connection module consists of three ProbSparse self-attention layers and two distillation layers. To ensure that feature maps output by two layers have the same shape when combined, the 1×1 convolution is used to merge outputs of the first ProbSparse self-attention layer and the third ProbSparse self-attention layer in the main encoder, ensuring effective feature information transmission.

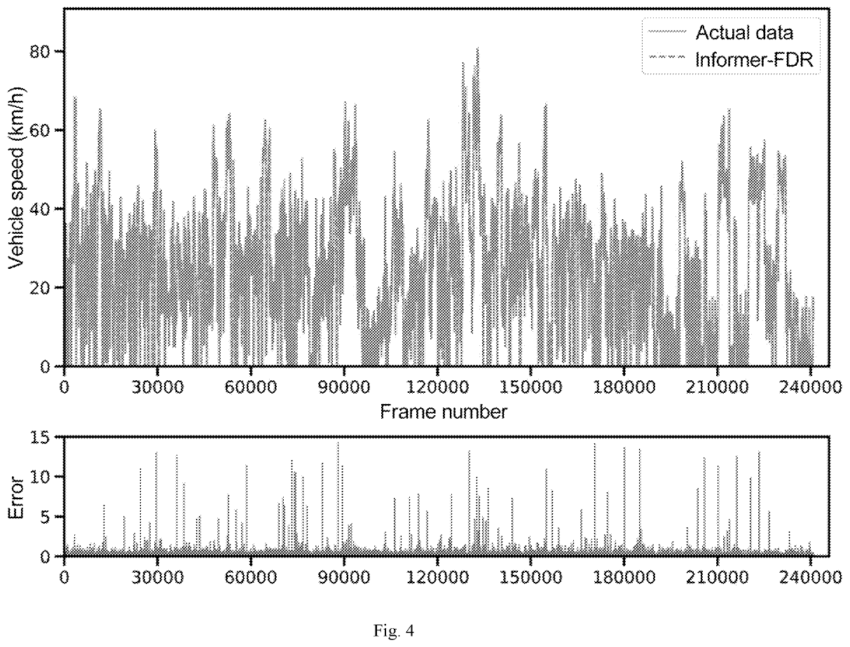

To verify the vehicle speed prediction effect of the method of this disclosure in the car-following scenario, the car-following dataset constructed in the embodiment is used for training. The vehicle speed 2 seconds later is predicted, and the absolute error between the actual value and the predicted value for each frame was calculated. The test results and errors were shown in FIG. 4. Results showed that the error predicted by the method in the embodiment of this disclosure consistently remained at a low level, with only a few significant errors occurring, exhibiting a high degree of fit with the actual vehicle speed.

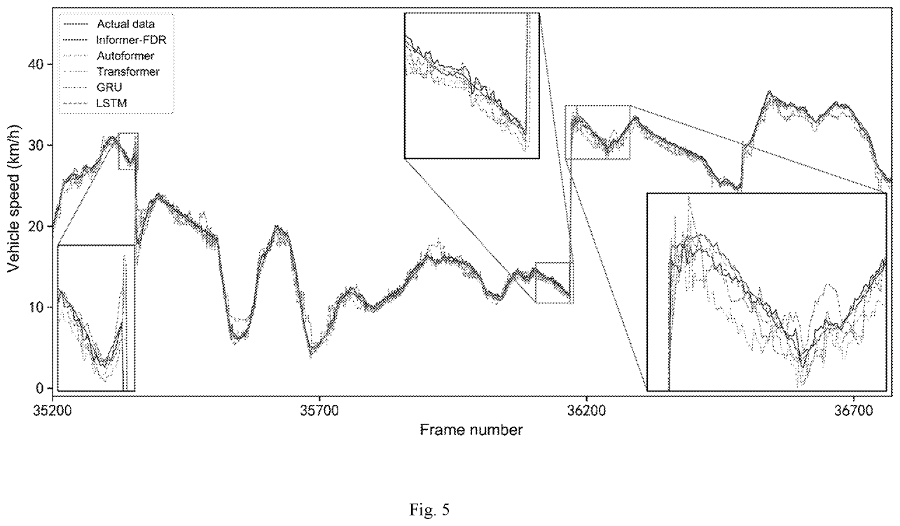

Furthermore, comparisons were made with other mainstream time series prediction methods to verify the superiority of this disclosure. FIG. 5 showed the comparative performance between the method of the present disclosure and other vehicle speed prediction methods in a specific car-following segment. FIG. 5 revealed GRU exhibited relatively poor prediction performance, while Autoformer, Transformer, and LSTM could capture the fluctuation trend of the data and some extreme values, but there was a certain degree of deviation in their predictions. Compared with other models, the Informer-FDR model achieved the best prediction performance, more accurately capturing the fluctuation trend of the data sequence and exhibiting a higher degree of fit with the actual data. In particular, the Informer-FDR model exhibited smaller prediction deviations at extreme points, indicating its ability to accurately capture random events in traffic scenarios.

In another embodiment, this disclosure provides a system for predicting vehicle speed considering the dynamic traffic environment in the car-following scenario, including a car-following case data extraction module, a feature fusion and normalization processing module, a redundant variable removal module, and a vehicle speed prediction model training and prediction output module.

The car-following case data extraction module is configured for extracting car-following case data by setting the standards and the thresholds for the car-following process in the naturalistic driving dataset.

The feature fusion and normalization processing module is configured for obtaining the traffic environment feature related to the car-following case data by using the target detection algorithm, and extracting the vehicle dynamics parameters from the car-following case data, fusing the vehicle dynamics parameters with the traffic environment features, and performing normalization processing to obtain the fused features.

The redundant variable removal module is configured for removing redundant variables from the fused features by using the combined feature selection method.

The vehicle speed prediction model training and prediction output module is configured for dividing the fused features after removal of the redundant variables into datasets, training the pre-established Informer-FDR vehicle speed prediction model, and obtaining the vehicle speed prediction result by using the trained Informer-FDR vehicle speed prediction model.

In another embodiment, this disclosure further provides an electronic device including: a memory storing at least one instruction; and a processor executing the instructions stored in the memory to implement the method for predicting vehicle speed considering the dynamic traffic environment in the car-following scenario.

In another embodiment, this disclosure further provides a computer-readable storage medium. The computer-readable storage medium stores a computer program. When executed by a processor, the computer program implements the method for predicting vehicle speed considering the dynamic traffic environment in the car-following scenario.

For example, the instructions stored in the memory may be divided into one or more modules/units. The one or more modules/units are stored in the computer-readable storage medium and executed by the processor to accomplish the method for predicting vehicle speed considering the dynamic traffic environment in the car-following scenario according to the present disclosure. The one or more modules/units may be a series of computer-readable instruction segments capable of performing specific functions. The instruction segments are used to describe the execution process of the computer program in a server.

The electronic device may be a computing device such as a smart phone, a notebook computer, a handheld computer, or a cloud server. The electronic device may include, but is not limited to, a processor and a memory. Those skilled in the art will understand that electronic devices may also include more or fewer components, or combinations of certain components, or different components. For example, the electronic device may further include input/output devices, network access devices, or buses.

The processor may be a Central Processing Unit (CPU), or it may be other general-purpose processors, a Digital Signal Processor (DSP), an Application Specific Integrated Circuit (ASIC), a Field-Programmable Gate Array (FPGA), or other programmable logic devices, discrete gate or transistor logic devices, ot discrete hardware components. The general-purpose processor may be a microprocessor or any conventional processor.

The memory may be an internal storage unit of the server, such as a hard disk or memory of the server. The memory may also be an external storage device of the server, such as a plug-in hard disk, a Smart Media Card (SMC), a Secure Digital (SD) card, or a Flash Card equipped on the server. Furthermore, the memory may include both an internal storage unit and an external storage device of the server. The memory is used to store the computer-readable instructions as well as other programs and data required by the server. The memory may also be used to temporarily store data that has been output or is to be output.

It should be noted that information interaction and execution processes among the above-mentioned modules, which are based on the same concept as the method embodiments, have their specific functions and technical effects detailed in the method embodiments. Therefore, they will not be repeated here.

Those skilled in the art can understand that, for the sake of description and brevity, the division of the above-described functional modules is merely illustrative. In actual application, the functions described above may be allocated to different functional units or modules as needed. That is, the internal structure of the device may be divided into different functional units or modules to perform all or part of the functions described above. The functional units and modules in the embodiments may be integrated into one processing unit, or each unit may exist physically as a separate unit, or two or more units may be integrated into one unit. The integrated units may be implemented in the form of hardware or in the form of software functional units. In addition, specific names of the functional units and modules are merely for distinguishing purposes and are not intended to limit the present disclosure. The specific operational processes of the units and modules in the system may refer to the corresponding processes in the method embodiments and are not repeated herein.

When the integrated unit is implemented in the form of a software functional unit and sold or used as an independent product, it may be stored in a computer-readable storage medium. Based on such an understanding, all or part of the processes in the methods in the above embodiments may be implemented by a computer program instructing relevant hardware. The computer program may be stored in a computer-readable storage medium. When executed by a processor, the computer program may implement the steps of the above method embodiments. The computer program includes computer program code, which may be in the forms of source code, object code, or an executable file, or certain intermediate forms. The computer-readable medium may include at least any entity or devices capable of conveying the computer program code to a photographic device or terminal device, a recording medium, computer memory, read-only memory (ROM), random access memory (RAM), an electrical carrier signal, a telecommunication signal, and a software distribution medium, such as a USB flash drive, a removable hard disk, a magnetic disk, or an optical disk.

In the above embodiments, each embodiment emphasizes different aspects. Parts not detailed or recorded in a particular embodiment may reference the related descriptions in other embodiments.

Described above are merely embodiments of the disclosure, which are not intended to limit the disclosure. It should be understood that any modifications and replacements made by those skilled in the art without departing from the spirit of the disclosure should fall within the scope of the disclosure defined by the appended claims.

What is claimed is:

1. A method for predicting vehicle speed considering a dynamic traffic environment in a car-following scenario, comprising:
extracting car-following case data by setting a standard and a threshold for a car-following process in a naturalistic driving dataset;
obtaining a traffic environment feature related to the car-following case data by using a target detection algorithm, and extracting a vehicle dynamics parameter from the car-following case data, fusing the vehicle dynamics parameter with the traffic environment feature, and performing normalization processing to obtain a fused feature;
removing a redundant variable from the fused feature by using a combined feature selection method; and
dividing the fused feature after removal of the redundant variable into datasets, training a pre-established Informer-FDR (Fusion features, Dilated causal convolution, and Residual connection) vehicle speed prediction model, and obtaining a vehicle speed prediction result by using a trained Informer-FDR vehicle speed prediction model;
wherein the pre-established Informer-FDR vehicle speed prediction model is configured to replace a max pooling layer of a distillation layer in a decoder of an Informer deep learning model with an average pooling layer, and change a convolutional layer to dilated causal convolution; the dilated causal convolution consists of causal convolution and dilated convolution; the causal convolution is subject to time constraint limitations, convolving an output at time t only with elements at time t and earlier in a previous layer to ensure causality in time series prediction, so that network output information is only influenced by past input information;
an operation of the dilated convolution is expressed as:
$$F ( s ) = {\sum }_{i = 0}^{K - 1} {F}_{i} * {X}_{t - d \cdot i} ;$$
wherein K is a size of a convolution kernel, s is an element of X, Fᵢ is a weight of the convolution kernel, t is a time step, and t−d·i denotes a past direction;
the pre-established Informer-FDR vehicle speed prediction model is configured to introduce Parametric Rectified Linear Unit (PReLU) as an activation function of the distillation layer, PReLU shifts an output mean toward zero, and an improved distillation operation is as follows:
$${X}_{j + 1}^{t} = AvgPool ( P Re LU ( DCConv ( {[ {X}_{j}^{t} ]}_{A B} ) ) ) ;$$
wherein probabilistic sparse (ProbSparse) self-attention is contained in [⋅]_{AB}; the dilated causal convolution is implemented through DCConv(⋅); PReLU(⋅) represents the activation function, and a final output is generated through AvgPool(⋅); and
the pre-established Informer-FDR vehicle speed prediction model is configured to incorporate a residual connection module; the residual connection module consists of three ProbSparse self-attention layers and two distillation layers, and three ProbSparse self-attention layers are a first ProbSparse self-attention layer, a second ProbSparse self-attention layer, a third ProbSparse self-attention layer; to ensure that feature maps output by the first ProbSparse self-attention layer and the third ProbSparse self-attention layer have the same shape when added together, a 1×1 convolution is used to merge an output of the first ProbSparse self-attention layer with an output of the third ProbSparse self-attention layer in a main encoder, ensuring effective transmission of feature information.

2. The method of claim 1, wherein in the step of “extracting car-following case data by setting the standard and the threshold for the car-following process in the naturalistic driving dataset”, the standard and threshold for the car-following process are as follows, data is selected as the car-following case data when following conditions are simultaneously met:
a relative speed between a leading vehicle and a following vehicle is less than 2.5 m/s;
a lateral offset between the leading vehicle and the following vehicle is less than 2.5 m; and
a following duration is greater than 10 s; and
car-following case data is divided into two road types: urban roads and highways.

3. The method of claim 1, wherein the step of “obtaining the traffic environment feature related to the car-following case data by using the target detection algorithm” comprises:
using a YOLOv5 (You Only Look Once version 5) target detection algorithm to detect a vehicle and a traffic participant in adjacent lanes, and defining a traffic density based on the number of vehicles traveling in a same direction as a host vehicle captured by a camera, wherein a case where the number of vehicles traveling in the same direction is 1 to 2 is defined as a low traffic density, a case where the number of vehicles traveling in the same direction is 3 to 4 is defined as a medium traffic density, and a case where the number of vehicles traveling in the same direction is greater than 4 is defined as a high traffic density; and a pedestrian and a cyclist recognized by the YOLOv5 target detection algorithm are merged into a unified category, defined as vulnerable road users, as input features for the Informer-FDR vehicle speed prediction model.

4. The method of claim 1, wherein when extracting the vehicle dynamics parameter from the car-following case data, driving information of a host vehicle is read via a CAN bus, the driving information of the host vehicle comprising a speed, an acceleration, a relative distance, an accelerator pedal position, and time headway.

5. The method of claim 1, wherein the step of “removing the redundant variable from the fused feature by using the combined feature selection method” comprises:
calculating a correlation between a candidate input feature and a speed of a host vehicle using Maximal Information Coefficient (MIC), Classification and Regression Tree (CART), Random Forest (RF), and eXtreme Gradient Boosting (XGBoost) algorithm; and
calculating an average value for each candidate variable by summing correlation results of four different algorithms and dividing by a total number of algorithms, sequentially calculating and ranking all variables, and selecting top-ranked variables with highest importance as model inputs based on the ranking.

6. The method of claim 1, wherein the Informer-FDR vehicle speed prediction model is established based on the Informer deep learning model through steps of:
in a rolling prediction setting with a fixed window size, an input at a time point t is expressed as:
$$X = \{ {x}_{1} , {x}_{2} , … , {x}_{N} \vert {x}_{i} ∈ {▯}^{L \times D} \} ;$$
wherein L is a sample sequence length, and D is a feature dimension; and in X, a single data sample is expressed as:
$${x}_{i} = \{ {t}_{i}^{1} , {t}_{i}^{2} , … , {t}_{i}^{L} \vert {t}_{i}^{j} ∈ {▯}^{1 \times D} \} ;$$
wherein
$${t}_{i}^{j}$$
represents data of an i-th model input at a j-th time step;
a speed of a host vehicle is used as an output indicator:
$$Y = \{ {y}_{1} , {y}_{2} , … , {y}_{N} \vert {y}_{i} ∈ {▯}^{1} \} ;$$
wherein yᵢ represents an output of the i-th model at each time step;
an encoder of the Informer deep learning model is formed by stacking a multi-head ProbSparse self-attention mechanism and a distillation operation:
$$\overline{A} ( Q , K , V ) = Soft max ( \frac{\overline{Q} {K}^{T}}{\sqrt{d}} ) V ;$$
wherein Q̅ is a sparse matrix containing sparsity measurements; Q and K generated during an encoder training process represent a query vector and a key vector, respectively; and V represents a value vector; d represents an input dimension; and a ProbSparse self-attention mechanism is expressed as:
$$\overline{M} ( {q}_{i} , K ) = max \{ \frac{{q}_{i} {k}_{j}^{T}}{\sqrt{d}} \} - \frac{1}{{L}_{K}} {\sum }_{{j = 1}^{}}^{{L}_{K}} \frac{{q}_{i} {k}_{j}^{T}}{\sqrt{d}} ;$$
wherein L_{K} is expressed as 1/L_{K}=q(kⱼ|qᵢ); i queries for sparsity measurements are expressed as qᵢ; and qᵢ and kⱼ are derived from Q and K, respectively;
the Informer deep learning model incorporates a convolutional layer and a max pooling layer between each pair of self-attention layers to reduce an input length; after a preceding self-attention layer, a convolutional layer with a kernel size of 3 and a stride of 1 is employed to enhance perception of contextual information features; subsequently, a max pooling layer with a kernel size of 3 and a stride of 2 is employed to prioritize main features, thereby generating smaller but more concentrated feature maps for subsequent self-attention layers:
$${X}_{j + 1}^{t} = MaxPool ( ELU ( Conv 1 d ( {[ {X}_{j}^{t} ]}_{A B} ) ) ) ;$$
wherein the ProbSparse self-attention is contained in [⋅]_{AB}; 1-D convolutional filtering is implemented through Conv(⋅); ELU(⋅) represents an activation function; and
the encoder combines the ProbSparse self-attention and the distillation operation to generate the feature map;
a time series X_{feed_te}^{t} input in the decoder of the Informer deep learning model is divided into two parts: a known sequence
$${X}_{t o k e n}^{t}$$
before a predicted point and a prediction sequence
$${X}_{0}^{t}$$
requiring future data masking:
$${X}_{feed \_ de}^{t} = C o n c a t ( {X}_{t o k e n}^{t} , {X}_{0}^{t} ) ∈ {R}^{( {L}_{token} + {L}_{y} ) {d}_{𝔪od el} ;}$$
wherein Lₜₒₖₑₙ is a length of a start token sequence; L_{y} is a length of the prediction sequence; and d_{model} is a model dimension;
positional encoding is performed on each input information of sequence according to following formulas:
$$P {E}_{( pos , 2 j )} = sin \frac{p o s}{{( 2 {L}_{X} )}^{2 j} / {d}_{m o d e l}} ; and \\ {PE}_{( pos , 2 j )} = cos \frac{p o s}{{( 2 {L}_{X} )}^{2 h} / {d}_{m o d e l}} ;$$
wherein pos represents a feature vector position, and d_{model} represents a feature vector dimension; and given importance of time information for time series prediction, time information in the time series is encoded, and position information and time information are integrated and input into the Informer deep learning model.

7. A system for predicting vehicle speed considering a dynamic traffic environment in a car-following scenario, comprising:
a car-following case data extraction module;
a feature fusion and normalization processing module;
a redundant variable removal module; and
a vehicle speed prediction model training and prediction output module;
wherein the car-following case data extraction module is configured for extracting car-following case data by setting a standard and a threshold for a car-following process in a naturalistic driving dataset;
the feature fusion and normalization processing module is configured for obtaining a traffic environment feature related to the car-following case data by using a target detection algorithm, and extracting a vehicle dynamics parameter from the car-following case data, fusing the vehicle dynamics parameter with the traffic environment feature, and performing normalization processing to obtain a fused feature;
the redundant variable removal module is configured for removing a redundant variable from the fused feature by using a combined feature selection method; and
the vehicle speed prediction model training and prediction output module is configured for dividing the fused feature after removal of the redundant variable into datasets, training a pre-established Informer-FDR vehicle speed prediction model, and obtaining a vehicle speed prediction result by using a trained Informer-FDR vehicle speed prediction model; and
wherein the pre-established Informer-FDR vehicle speed prediction model is configured to replace a max pooling layer of a distillation layer in a decoder of an Informer deep learning model with an average pooling layer, and change a convolutional layer to dilated causal convolution; the dilated causal convolution consists of causal convolution and dilated convolution; the causal convolution is subject to time constraint limitations, convolving an output at time t only with elements at time t and earlier in a previous layer to ensure causality in time series prediction, so that network output information is only influenced by past input information;
an operation of the dilated convolution is expressed as:
$$F ( s ) = {\sum }_{i = 0}^{K - 1} {F}_{i} * {X}_{t - d \cdot i} ;$$
wherein K is a size of a convolution kernel, s is an element of X, Fᵢ is a weight of the convolution kernel, t is a time step, and t−d·i denotes a past direction;
the pre-established Informer-FDR vehicle speed prediction model is configured to introduce PReLU as an activation function of the distillation layer, PReLU shifts an output mean toward zero, and an improved distillation operation is as follows:
$${X}_{j + 1}^{t} = AvgPool ( P Re LU ( DCConv ( {[ {X}_{j}^{t} ]}_{A B} ) ) ) ;$$
wherein ProbSparse self-attention is contained in [⋅]_{AB}; the dilated causal convolution is implemented through DCConv(⋅); PReLU(⋅) represents the activation function, and a final output is generated through AvgPool(⋅); and
the pre-established Informer-FDR vehicle speed prediction model is configured to incorporate a residual connection module; the residual connection module consists of three ProbSparse self-attention layers and two distillation layers, and three ProbSparse self-attention layers are a first ProbSparse self-attention layer, a second ProbSparse self-attention layer, a third ProbSparse self-attention layer; to ensure that feature maps output by the first ProbSparse self-attention layer and the third ProbSparse self-attention layer have the same shape when added together, a 1×1 convolution is used to merge an output of the first ProbSparse self-attention layer with an output of the third ProbSparse self-attention layer in a main encoder, ensuring effective transmission of feature information.
